(19) United States
(12) Patent Application Publication
(10) Pub. No.: US 2020/0086624 A1
(43) Pub. Date: Mar. 19, 2020

(54) METHOD AND SYSTEM OF MANUFACTURING A LOAD-BEARING STRUCTURE AND A LOAD-BEARING STRUCTURE MANUFACTURED THEREOF

(71) Applicant: AGENCY FOR SCIENCE, TECHNOLOGY AND RESEARCH, Singapore (SG)

(72) Inventors: Stephen DAYNES, Singapore (SG); Stefanie FEIH, Singapore (SG); Jun WEI, Singapore (SG)

(21) Appl. No.: 16/472,860

(22) PCT Filed: Dec. 21, 2017
(86) PCT No.: PCT/SG2017/050637

§ 371 Date: Jun. 21, 2019

(30) Foreign Application Priority Data
Dec. 22, 2016 (SG) 10201610776X

(51) Int. Cl. B33Y 10/00; G06F 17/50; B32B 5/14; B33Y 50/02

(52) U.S. Cl. CPC B33Y 10/00; G06F 17/5018; G06F 2217/12; B32B 5/14; B33Y 50/02; G06F 17/5086

(57) ABSTRACT

A method of manufacturing a load-bearing structure. The method may include establishing overall dimensions and expected loading conditions of the load-bearing structure; determining a material density distribution within a solid model for the load-bearing structure based on the overall dimensions and the expected loading conditions for a predetermined objective end constraint; generating stress field data for the determined material density distribution based on the expected loading conditions; transforming the solid model into a spatially-graded mesh model having a plurality of three-dimensional cells based on orthogonal isostatic lines populated along principal stress directions of the stress field data; and fabricating the load-bearing structure with truss members aligned according to the spatially-graded mesh model. A system for manufacturing a load-bearing structure and a load-bearing structure manufactured thereof.

### CROSS-REFERENCE TO RELATED APPLICATIONS

The present application claims the benefit of the Singapore patent application No. 10201610776X filed on 22 Dec. 2016, the entire contents of which are incorporated herein by reference for all purposes.

### TECHNICAL FIELD

Embodiments generally relate to a method of manufacturing a load-bearing structure, a system for manufacturing a load-bearing structure, and a load-bearing structure manufactured thereof.

### BACKGROUND

In recent years, weight-saving optimization strategies have been available in most commercial software codes utilizing the finite element method for structural analysis. These lead to the representation of lightweight material structures in the form of truss elements of various unit cell configurations. Such lattice structures are exceeding the structural performance of conventional solid materials for example in lightweight sandwich core structures, medical implants and a new class of lattice-type metamaterials with specific mechanical and thermal properties.

Leading software companies in the structural analysis sector include Dassault Systèmes (CATIA/Abaqus), Altair Hyperworks and Autodesk Within. These packages all include features to place lattice structures of varying unit cell type within low density material regions. In particular, for example in the software from Altair Hyperworks, the software is able to perform individual optimization of each truss diameter within the lattice configuration and to generate tapered lattice trusses to minimize stress concentrations at lattice junctions.

However, although the diameter of each lattice member can be optimized for density with such commercially available software, this is not always a desirable solution since any large changes in diameter at lattice nodes (the truss joint) can lead to large stress concentrations. While the proposed approach of tapered diameters by Altair Hyperworks is an improvement, it leads to poorly understood failure mechanisms of trusses due to potentially large diameter variations within a cell. Furthermore, the concept of changing lattice diameters alone will only be effective within a certain diameter range as, for example, each three-dimensional (3D) printing process has a minimum and maximum printable member size.

### SUMMARY

According to various embodiments, there is provided a method of manufacturing a load-bearing structure. The method may include establishing overall dimensions of the load-bearing structure and establishing expected loading conditions which the load-bearing structure is to be subjected to. The method may further include determining a material density distribution within a solid model for the load-bearing structure based on the overall dimensions and the expected loading conditions for a predetermined objective end constraint(s), for example such as volume constraint, mass constraint, thermal load constraint, vibration load constraint, or other constraint(s) as required by a person creating the load-bearing structure. The method may further include generating stress field data or stress derived field output such as strain of the solid model of the load-bearing structure having the determined material density distribution based on the expected loading conditions. The method may further include transforming the solid model into a spatially-graded mesh model having a plurality of three-dimensional cells for the load-bearing structure based on orthogonal isostatic lines populated along principal stress directions of the stress field data or the stress derived field output of the solid model. The method may further include fabricating the load-bearing structure with truss members aligned according to the spatially-graded mesh model.

According to various embodiments, there is provided a system for manufacturing a load-bearing structure. The system may include a material density distribution determiner configured to receive overall desired dimensions of the load-bearing structure, to receive expected loading conditions which the load-bearing structure is to be subjected to, to determine a material density distribution of a solid model for the load-bearing structure based on the overall dimensions and the loading conditions for a predetermined objective end constraint(s), and to generate stress field data or stress derived field output of the solid model of the load-bearing structure having the material density distribution based on the expected loading conditions. The system may further include a spatially-graded mesh model generator configured to transform the solid model into a spatially-graded mesh model having a plurality of three-dimensional cells based on orthogonal isostatic lines populated along principal stress directions of the stress field data or the stress derived field output of the solid model. The system may further include a load-bearing structure fabricator configured to fabricate the load-bearing structure with truss members aligned according to the spatially-graded mesh model generated.

According to various embodiments, there is provided a load-bearing structure including truss members aligned according to a spatially-graded mesh model. The spatially-graded mesh model may include a plurality of three-dimensional cells. Members of each cell of the plurality of three-dimensional cells of the spatially-graded mesh model may be aligned to orthogonal isostatic lines populated along principal stress directions of stress field data or stress derived field output generated for a material distribution density for a solid model for the load-bearing structure which is determined based on overall dimensions of the load-bearing structure and expected loading conditions of the load-bearing structure for a predetermined objective end constraint(s). Each member of each cell of the plurality of three-dimensional cells of the spatially-graded mesh model may be a straight member.

### BRIEF DESCRIPTION OF THE DRAWINGS

For a more complete understanding of the description provided herein and the advantages thereof, reference is now made to the brief descriptions below, taken in connection with the accompanying drawings and detailed description, wherein like reference numerals represent like parts. In the drawings, figures are not necessarily to scale, emphasis instead generally being placed upon illustrating the principles of the invention. In the following description, various embodiments are described with reference to the following drawings.

FIG. 1 shows a method of obtaining a spatially-graded mesh model for manufacturing of a load-bearing structure according to various embodiments;

FIG. 2 shows an example of the construction of orthogonal isostatic lines according to various embodiments;

FIG. 3(a) shows a lower bound of the body-centered-cubic (BCC) unit cell density range after size optimization;

FIG. 3(b) shows an upper bound of the BCC unit cell density range after size optimization;

FIG. 4 shows an optimized core density distribution (or optimized material density distribution) showing boundary conditions and beam dimensions;

FIG. 5(a) shows the conventional uniform density lattice structure;

FIG. 5(b) shows a conventional diameter-graded lattice structure;

FIG. 5(c) shows a spatially-graded lattice structure according to various embodiments;

FIG. 6(a) shows the distribution of isostatic lines obtained according to the various embodiments;

FIG. 6(b) shows an example of a final spatially-graded mesh model according to various embodiments;

FIG. 6(c) shows a perspective view of the final spatially-graded mesh model of FIG. 6(b) according to various embodiments;

FIG. 7 shows a load-bearing structure fabricated according to a method of manufacturing a load-bearing structure according to various embodiments;

FIG. 8(a) and FIG. 8(b) show a variation to the method of FIG. 1 according to various embodiments;

FIG. 9 shows a schematic diagram of a method of manufacturing a load-bearing structure according to various embodiments;

FIG. 10 shows a system for manufacturing a load-bearing structure according to various embodiments;

FIG. 11 shows the experimental force-displacement characteristics of three different sandwich lattice structures under three point bending;

FIG. 12 shows the normal distributions of maximum von Mises stress in the finite element models' lattice members;

### DETAILED DESCRIPTION

Embodiments described below in context of the apparatus are analogously valid for the respective methods, and vice versa. Furthermore, it will be understood that the embodiments described below may be combined, for example, a part of one embodiment may be combined with a part of another embodiment.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

Functionally graded lattice core structures have recently emerged as a new class of material that shows a gradual variation in their material properties with the aim of improving structural performance whilst minimizing weight. Continuous variation in properties may be important in a range of structural applications to minimize stress concentrations. A functionally graded sandwich core structure may be useful in applications such as for core materials in bending or impact where there is a variation in stress field data through the thickness of the structure.

In practice, a continuously changing stiffness covering a large stiffness range may be difficult to achieve. Recently, advances in topology optimization approaches have resulted in new approaches to achieve functionally graded material structures. Through the development of a level-set method for topology and material property optimization, it has been demonstrated that an optimum configuration for functionally graded structures may be achieved assuming a continuous medium that may vary its stiffness through the dispersion of two materials. An alternative approach is to configure lattice structures with smoothly varying porosity to realize optimal stiffness gradients. Truss-like lattice structures have been demonstrated to have excellent stiffness and strength performance when used as a core material in sandwich structures. Functionally graded lattices have also been demonstrated to have excellent energy absorbing capabilities whereby cells may be designed to progressively collapse under compressive loads prior to final densification. However, there remains a potential for further improvements of these mechanical properties.

Various embodiments of a method of manufacturing a load-bearing structure, a system for manufacturing a load-bearing structure and a load-bearing structure have been provided to address at least some of the issues identified earlier.

Various embodiments may enable the construction of functionally graded lattice structures with optimized cell size, cell orientation and cell aspect ratios in order to achieve superior strength and stiffness of lightweight load-bearing structures.

Various embodiments have provided a novel concept for the generation and optimal configuration of functionally graded lattice core structures for stiffness and strength. Using a combined methodology of topology optimization and size optimization, principal stress directions in a topology optimized structure may be identified and truss geometries with optimized diameters may be aligned with the established isostatic stress lines.

According to various embodiments, a unifying approach to optimize variation of the size, shape and orientation of each individual lattice cell may be provided. According to various embodiments, theory from solid mechanics (Mohr's circle for stress and isostatic lines) may be used in order to uniquely tailor the size, shape and orientation of each cell using information from the principal stress fields for optimized density. According to various embodiments, the diameter variability between neighboring lattice cells (and hence potential stress concentration at joints) may be reduced significantly.

According to various embodiments, load-bearing lightweight structures may be configured by aligning truss members with principal stress directions (isostatic stress lines) for each lattice cell through consideration of the topology-optimized density variation in a structure exposed to a specific loading scenario. Various embodiments have provided for automated individual optimization of each lattice cell in a functionally-graded connected lattice network based on (a) cell size, (b) cell shape, and (c) cell orientation. Various embodiments have provided automated generation of sandwich structures containing optimized functionally graded lattice cores with enhanced strength and stiffness.

Various embodiments have provided a novel approach to generate optimized functionally graded lattice core structures. Firstly, topology optimization may be performed to return the optimal density distribution to minimize the structure's compliance subject to a predetermined objective end constraint, such as a mass constraint or a volume constraint or a thermal load constraint or a vibration load constraint or any other constraint(s) as required by a person creating the lattice core structure. A series of isostatic lines may then be constructed with respect to the local principal stresses to generate a lattice structure spatially-graded with respect to lattice cell size, aspect ratio and orientation. Various embodiments may significantly outperform lattice structures with graded diameters as optimized by state-of-the-art commercial software packages.

Various embodiments have developed a novel methodology for producing spatially-graded lattice structures based on nature's principles. According to various embodiments, isostatic force lines may be calculated based on local direction of principal stresses. According to various embodiments, the isostatic force line method may result in optimum cell orientation, size and aspect ratio of unit cells. According to various embodiments, the spatially-graded lattice structure may have significantly higher stiffness and strength than uniform lattices of the same weight.

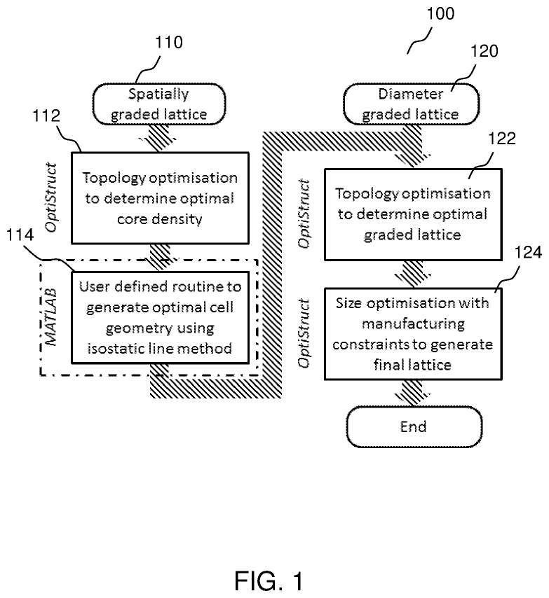

FIG. 1 shows a method of obtaining a spatially-graded mesh model for manufacturing of a load-bearing structure according to various embodiments. According to various embodiments, the method may be able to optimize lattice cell size, aspect ratio and orientation, which are not available in any conventional methods since the cell size is mesh-dependent and is conventionally not considered as an optimization variable. According to various embodiments, the new lattice structure configuration may be generated in an automated manner for potentially complex geometric configurations and multiple load cases. The integrated approach may build on or add on to existing framework in conventional methods. For example, this new functionality may be introduced as an additional user defined routine. The user defined routine may be implemented in a computer-implemented method, for example through using MATLAB. This approach may introduce two additional steps prior to diameter grading of the lattice and final size optimization, as shown in FIG. 1. To spatially-grade the lattice cells, topology optimization may be used at first to determine the optimal density distribution and bulk stress state within the core (or the solid model of the load-bearing structure). This step may be similar to the diameter grading procedure. Data may then be output for the stress field data components, such as in-plane stress components (σₓ, σ_{y} and σ_{xy}), within the topology optimized core (or the solid model of the load-bearing structure). This data may enable the maximum principal stresses to be determined in addition to their orientation (σ₁, σ₂ and θ, respectively) using the equations of statics or the Mohr's circle approach. An optimal spatially-graded mesh model may then be produced based on this stress data using the isostatic line method, which may be described in more detail in the following. The optimal spatially-graded mesh model may then finally be re-analyzed in using the two-step procedures used for the diameter-graded lattice, which may correspond to obtaining the final optimal truss diameters.

As shown in FIG. 1, the method 100 may include, at 110, obtaining a spatially-graded lattice for a load-bearing structure. Obtaining the spatially-graded lattice may include, at 112, performing topology optimization to determine an optimal core density of a solid model for the load-bearing structure. A solid model for the load-bearing structure may be an uninterrupted continuous model of the load-bearing structure free of any empty void or space or gap. Subsequently, at 114, a user defined routine may be used to generate optimal cell geometry using isostatic line method. Accordingly, the isostatic lines populated from the isostatic line method may segment the solid model into a plurality of unit blocks, wherein each unit block may define the geometry of the respective lattice cell. The method 100 may further include, at 120, diameter grading procedures. The diameter grading procedures may include, at 122, performing topology optimization to determine optimal graded lattice. Hence, each unit block obtained from 114 may be transformed into respective lattice cell with beam members optimized based on the density of the respective unit block such that the diameter or width profile of the respective beam members of the respective lattice cell may be equivalent to the density of the respective unit block. Accordingly, the solid model may be transformed into a spatially-graded lattice or a spatially graded mesh model. Subsequently, the method 100 may further include, at 124, performing size optimization with manufacturing constraints such that the diameter or width of each beam member may be optimized to generate a final lattice or the final spatially graded mesh model, which may be used for manufacturing or fabrication of the load-bearing structure. According to various other embodiments, the step 122 may be skipped so as to proceed directly to step 124. However, in such a case, each unit block may be transformed into a lattice cell with uniform beam members prior to the step 124. Subsequently, to perform size optimization at 124 starting from a beam member with uniform diameter or width may be harder or more troublesome for finding an optimal solution. Accordingly, step 122, may enable a good ‘starting point’ to be found prior to the size optimization in 124.

According to various embodiments, the resulting distribution of cells (as shown in FIG. 5(c)) may be significantly different from the arrangements obtained with the conventional approaches (as seen in FIG. 5(a) or FIG. 5(b)). The aspects of the new concept, namely size optimization, aspect ratio optimization and optimized cell orientation may be clearly distinct from the conventional approaches. Further, diameter variations between neighboring cells may now be minimal which may minimize stress concentrations at truss joints.

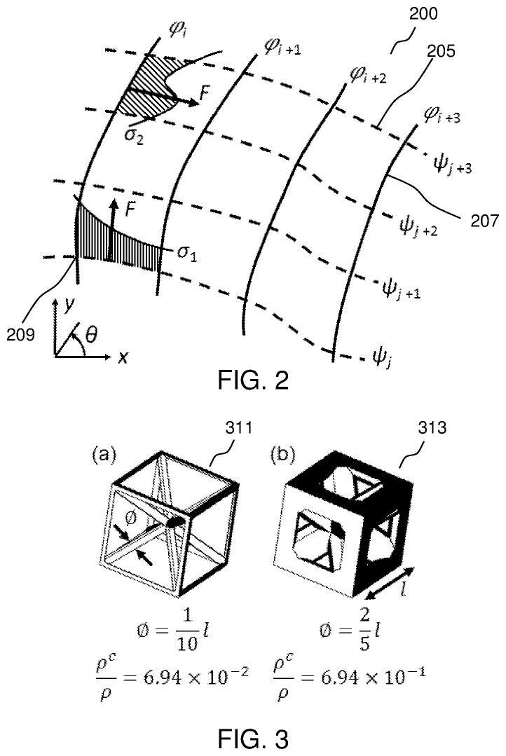

FIG. 2 shows an example 200 of the construction of orthogonal isostatic lines or the isostatic line method 113 of the method 100 according to various embodiments. According to various embodiments, the construction of isostatic lines in a solid model of a load-bearing structure for use in the generation of spatially-graded lattice cells of the load-bearing structure may be performed according to the following example.

With a given set of stress data in a two-dimensional (2D) plane, which may be obtained numerically (for example via finite element analysis), it may be possible to construct two orthogonal sets of isostatic lines 205, 207 that describe the maximum and minimum principal stress trajectories within a density-optimized core of the solid model. Since these isostatic lines may be aligned with the principal stress trajectories, they may be by definition free of shear stress. A general analytical method for the construction of isostatic lines may not be known so a numerical approach may be adopted. The numerical construction of isostatic lines may be a further development where stress data may be numerically integrated along the stress trajectories using Euler's method.

According to various embodiments, the construction of isostatic lines may be implemented using computer software, such as MATLAB, and interfaced with input and output files of conventional structure analysis software, e.g. OptiStruct, in order to generate the spatially-graded lattice meshes. The first step may be to select a starting point 209 to commence integration. For example, a corner on the structure's boundary (or the solid model's boundary) may be a convenient point to place an initial isostatic line. Once a starting point is defined, orthogonal lines may be drawn based on the local principal stresses (σ₁, σ₂) until they reach a point outside of the structure's domain (or the solid model's domain). The angle θ defining the principal stress direction at a point along with the derivation of the principal stresses from the global stress components may be defined. The orientation of the maximum principal stress may be found using:

$$θ = \frac{1}{2} {tan}^{- 1} ( \frac{{τ}_{xy}}{{σ}_{x} - {σ}_{y}} ) \qquad ( 1 )$$

The stress components at a given point in terms of the global coordinate system σₓ, σ_{xy} and τ_{xy} may be found by interpolating the stress data from the finite element analysis. An isostatic line may then be traced by incrementally moving by distance ds₁ in the direction of θ or by moving a distance ds₂ orthogonal to the direction of θ and calculating the relative movements in the global coordinate system.

σ₁: dx=ds₁ cos θ, dy=ds₁ sin θ

σ₂: dx=ds₂ sin θ, dy=ds₁ cos θ (2)

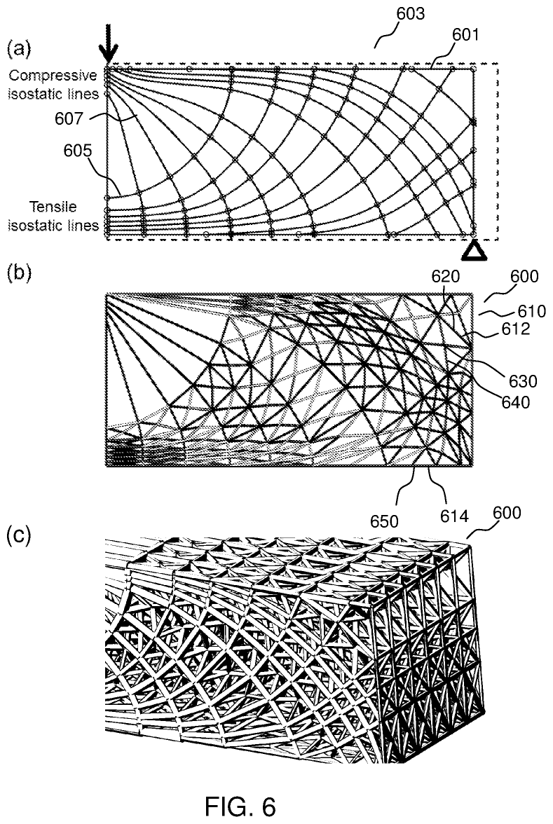

Once the first two isostatic lines are defined (φᵢ, ψⱼ), it may then be possible to calculate the trajectories of successive isostatic lines (φᵢ₊₁, ψⱼ₊₁). The positions of the successive isostatic lines may be determined numerically using the following conditions:

$$F = \vert {{\sum }_{{ϕ}_{i}}}^{{ϕ}_{i + 1}} {σ}_{1} {dS}_{2} \vert = \vert {{\sum }_{{ψ}_{j}}}^{{ψ}_{j + 1}} {σ}_{2} {dS}_{1} \vert \qquad ( 3 )$$

Where F is a constant that determines the relative spacing of the isostatic lines and has dimensions of force per unit thickness. According to various embodiments, successive isostatic lines may also be spaced by an averaged distance. For example, FIG. 6(c) shows lines with a constant spacing in one direction.

While FIG. 2 shows the construction of two sets of orthogonal isostatic lines in the 2D plane, it is understood that in a three-dimensional (3D) model of a load-bearing structure, a third set of isostatic lines in a third direction which may be normal to the 2D plane (i.e. orthogonal to the two sets of orthogonal isostatic lines in the 2D plane) or in the thickness direction of the solid model of the load-bearing structure may be constructed. According to various embodiments, when the solid model is subjected to 2D dominant loading conditions, variation of the stress in the third direction may be assumed to be negligible such that the third set of isostatic lines may be straight lines simply and directly extrapolated in the third direction.

According to various embodiments, this new approach may result in lattice configurations resembling biological structures. For example, the cellular structures within bone (trabeculae) which are oriented with respect to the principal stress directions within the femoral head.

According to various embodiments, the diameter grading procedures 120 may be according to the following example. As mentioned earlier, the isostatic lines populated from the isostatic line method at 114 may segment the solid model of the load bearing structure into a plurality of unit blocks.

Firstly, at 122, topology optimization may be applied to a unit block (or a three-dimensional (3D) solid element model) of the load-bearing structure resulting in an optimum density graded material. The porosity of this hypothetical material may be able to vary between 100% (fully densified) and 0% (empty space). The porous zones may then be explicitly transformed into the spatially-graded lattice cell including beam elements of varying cross-sectional diameters. The optimization methodology employed here may be in principle independent of the unit cell type. In a second step, at 124, the lattice member may be subjected to size optimization to achieve the target cell density. This may enable the diameter of each lattice member to be individually optimized. 3D additive manufacturing constraints may also be applied at this second step in the form of placing an upper and lower bound on feasible lattice diameters.

The edge length dimension of each lattice cell l may be determined by the initial mesh obtained from the isostatic method which is used for topology optimization and may therefore not be a variable in this optimization procedure. According to various embodiments, the lattice cells may include a body-centered-cubic lattice cell, and/or a face-centered-cubic lattice cell, and/or a base-centered-cubic lattice cell, and/or a hexahedron lattice cell, and/or a pentahedron lattice cell, and/or a tetrahedron lattice cell, and/or an octet-truss lattice cells, and/or any other types of suitable lattice cell, and/or a combination thereof. As shown in the example in FIG. 3, the lattice cells may be body-centered-cubic (BCC). This cell topology may have relatively linear and isotropic stiffness properties. The manufacturing constraints imposed during size optimization may limit the lattice beam diameters. For example, when the load-bearing structure is to be manufactured via 3D printing, the lattice beam diameters may be limited to a range of

$$\frac{1}{10} \leq \frac{∅}{l} \leq \frac{2}{5} ,$$

as shown in FIG. 3. FIG. 3(a) shows a lower bound 311 of the BCC unit cell density range after size optimization. FIG. 3(b) shows an upper bound 313 of the BCC unit cell density range after size optimization. This range of diameters may results in a range of densities which closely approximate the optimal densities shown in FIG. 3. A lower bound on the diameter may be required as each 3D printer has a minimum printing resolution. An upper bound may also be required as large values of

$$\frac{∅}{l}$$

may result in the formation of fused cells during 3D printing.

According to various embodiments, the method 100 may be used in conjunction with software capable of topology optimization and finite element analysis, such as, but not limited to, OptiStruct (Altair HyperWorks software suite). The Isostatic Stress Line Method may also be implemented using a coding language, such as Matlab, to operate. According to various embodiments, virtually any coding language may be used in practice. According to various embodiments, the method 100 may be a computer-implemented method or may be stored as a computer executable code in a computer-readable medium.

For illustrative purposes, the method and system according to various embodiments may be applied for the manufacturing of a load-bearing structure in the form of a sandwich core structure. The sandwich core structure may be desired to be subjected to three point bending. Non-dimensional core performance indices may be formulated to express the relative specific stiffness and strength properties of the core for comparison between the structure obtained from the method and system according to various embodiments and other structures obtained from conventional method and system, such as the uniform lattice structure with uniform truss (or a benchmark structure) and/or the diameter-graded lattice structure with variable diameter truss. Experiment tests have shown that the spatially-graded lattice structure according to the various embodiments has improved stiffness and strength properties (172% and 101%, respectively) when compared to the uniform lattice structure with uniform cell size of the same density.

According to various embodiments, the method and system according to various embodiments may be applied for the manufacturing of a load-bearing structure in the form of a flat sandwich structure, which is to be subjected to three points bending, according to the following example. In the flat sandwich structure, a lattice core may be used in combination with an upper and lower face sheet and a centrally applied load may be applied between two simply supported boundary conditions. The application of the method and system of the various embodiments to the manufacture of sandwich structure may be significant because lattice structures are generally used for core materials which are typically of low density comparative to the facing material when configured to withstand externally applied bending moments.

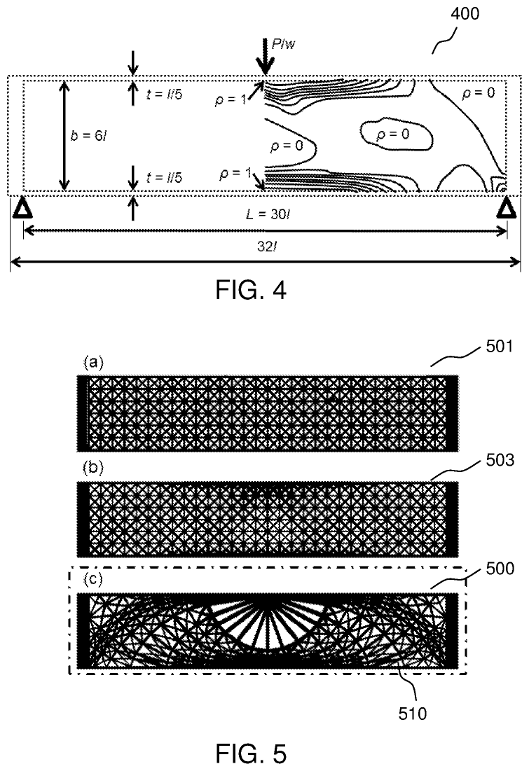

The geometry of the three point bending specimen and its topology optimized core (or solid model) density distribution may be found, for example via topology optimization in step 112 of method 100. FIG. 4 shows an optimized core (or solid model) density distribution 400 (or optimized material density distribution) showing boundary conditions and core (or solid model) dimensions. The dimensions in FIG. 4 have been defined in terms of the lattice cell size l. Each lattice cell may be a cube with volume l². The core (or solid model) may be six lattice cells thick (b=6l) and 30 lattice cells in length (L=30l). To reduce computational expense, only half of the core (or solid model) length may be modeled due to symmetry about the loading plane and the core (or solid model) may be only one lattice row wide (w=l). Modeling a single row of lattice cells may also ensure that the analysis simplifies to the case of two-dimensional plane stress. The thicknesses of the face sheets, t, are

$$\frac{l}{5}$$

each and end face sheets of thickness l are also included since the topology optimization returns zero-density results in regions where bending moments are not applied.

The objective of the topology optimization is to minimize the core (or solid model) compliance subject to a 25% minimum total volume constraint (or 75% mass loss) placed on the core material. This volume constraint may be set in a mostly arbitrary manner in this illustrative example, but works well with the manufacturing constraints. According to various embodiments, topology optimization may be performed to determine material density distribution for any predetermined objective end constraint(s), such as volume constraint, mass constraint, thermal load constraint, vibration load constraint, or any other constraint(s) as required. The predetermined objective end constraint(s) may be a consideration or a limitation or a requirement or a performance criteria of the load-bearing structure due to, for example, manufacturing technology or environmental factors or loading conditions or structural requirements or performance requirements in relation to the load-bearing structure. According to various embodiments, the optimization parameter may be configured to reduce the likelihood of voids forming in the core (or solid model). The optimized density distribution shown in FIG. 4 reveals two main phenomena. The first is that the highest density of close to 100% occurs near the face sheets at the mid-span. This is an intuitive result since these regions are subject to the highest tensile and compressive stresses. The second is an increase in density at the supports where reaction forces are applied to the structure (or solid model). In other regions the density varies with a minimum value of just under 5%.

For comparison purposes, a conventional uniform density lattice structure including beams with diameter equal to

$$\frac{∅}{6} = 0.5$$

and a conventional diameter-graded lattice structure may be used. Each structure may be configured to have a density of approximately 25% relative to the baseline material and 180 cells per row in the z-direction. The spatially-graded structure fabricated according to the various embodiments may have a total of 186 cells per row: 160 cells may have quadrilateral cross-sections and 26 may have triangular cross-sections. FIG. 5(a) shows the conventional uniform density lattice structure 501. FIG. 5(b) shows a conventional diameter-graded lattice structure 503. FIG. 5(c) shows a spatially-graded lattice structure 500 according to various embodiments.

FIG. 6(a) shows the distribution of isostatic lines 601 obtained for a solid model 603, for example in step 114 of method 100, according to the various embodiments. Lines which are subjected to tensile forces are indicated by reference 605. Lines which are subjected to compressive forces are indicated by reference 607. This distribution of isostatic lines may be generated using a non-dimensional force per unit thickness constant equal to

$$F = \frac{0.164}{P} .$$

This constant value may be selected in order to generate approximately 180 lattice cells along the length of the beam; consistent with the conventional uniform and the conventional diameter-graded structures. In the spatially-graded lattice structure, for example as obtained from step 122 and 124 of the method 100, lattice cells with triangular cross-sections may be considered as half cells as these cells may be typically generated when the isostatic lines intersect the boundary of the core (or solid model) domain and it may not be feasible to generate a full cell. This may result in a potential change in failure mode in this part of the structure as will be discussed later. It may also be noted on the structure boundary in FIG. 6(a) that some nodes may be very close to one another and that some very small cells may also be generated at the boundary of the structure domain. In such cases, these nodes may be either merged or deleted to avoid the formation of excessively small cells.

The rationalized spatially-graded lattice structure configuration after the removal and combining of these unnecessary nodes is shown in FIG. 6(b). Accordingly, FIG. 6(b) shows an example of a final spatially-graded mesh model 600 obtained after step 124 of the method 100 according to various embodiments. FIG. 6(c) shows a perspective view of the final spatially-graded mesh model 600 according to various embodiments. According to various embodiments, curvilinear isostatic lines may be discretised into straight beam segments. According to various embodiments, central nodes may also be introduced in each hexahedron cell to form the diagonal members of the BCC topology. The non-dimensional axial stress distribution after final size optimization may also be shown in FIG. 6(b). It may be seen that the resultant axial stress distribution may have the desired distribution of tension and compression forces reflecting the original isostatic line distribution. It may also be seen that the magnitude of the stresses in the lattice cross members may be comparatively low since the cells are by definition orientated to minimize shear stresses. Shear stresses may be introduced mainly due to the discretisation of curvilinear lines into straight beam segments.

According to various embodiments, the load-bearing structure may be manufactured according to the following. The spatially-graded mesh model (or the optimized finite element models) obtained from the various embodiments may be exported in solid geometry format (.stp) and then converted to stereolithography format (.stl), for example using SolidWorks, prior to 3D printing. The three structures used for comparison may be additively manufactured from VisiJet CR-WT ‘ABS-like’ material using a 3D Systems Projet 5500X printer. The material may have a flexural modulus of E=1.7 GPa, a density of ρ=1.17 g/cm³ and a flexural strength of σ_{y}=65 MPa. The manufactured conventional uniform lattice cell may have an edge length of l=5 mm, resulting in a minimum lattice beam diameter of ø=0.5 mm and a core with external dimensions L=150 mm and b==30 mm. The Projet 5500X printer may have a resolutions of 375×375×790 DPI (67 μm×67 μm×32 μm) in the x, y and z directions respectively.

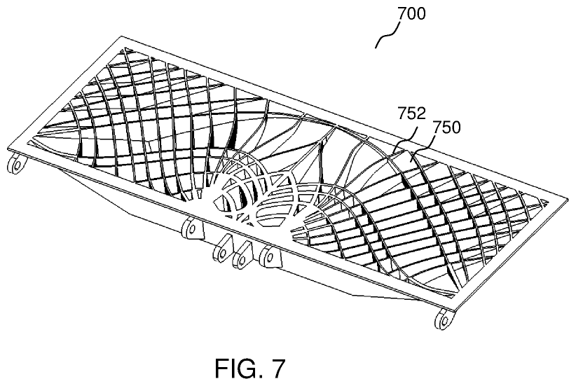

FIG. 7 shows a load-bearing structure 700 fabricated according to a method of manufacturing a load-bearing structure according to the various embodiments. According to various embodiments, the method of manufacturing the load-bearing structure 700 may include steps 112 and 114 of the method 100. However, instead of steps 122 and 124, the isostatic lines in the 2D plane may be extruded in a third direction which may be normal to the 2D plane (i.e. orthogonal to the two sets of orthogonal isostatic lines in the 2D plane) or in the thickness direction of the solid model of the load-bearing structure, such that the plurality of three-dimensional cells of the spatially-graded mesh model include box-like grid cells 750 with respective walls 752 aligned corresponding with the isostatic lines in the 2D plane. According to various embodiments, the load-bearing structure 700 obtained may have an optimized core, which may be manufactured by 3D printing, casting or subtractive machining. According to various embodiments, the load-bearing structure 700 in FIG. 7 may be an internal core of an aircraft airbrake which may be subjected to uniform pressure load on upper surface. The load-bearing structure 700 may be optimized for maximum stiffness subject to a volume constraint. In the load-bearing structure 700 as shown in FIG. 7, the stiffness may be nearly doubled compared to a structure with a uniform square design.

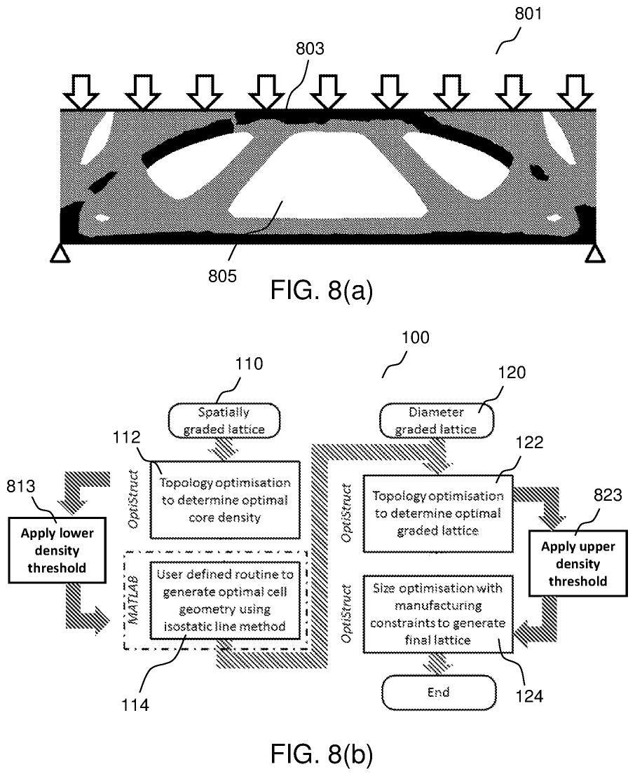

FIG. 8(a) and FIG. 8(b) shows a variation to the method 100 of FIG. 1 according to various embodiments. As shown, after topology optimization of the solid model of load-bearing structure 801 at step 112 of the method 800, low density prescribed threshold may be removed at step 813 to form voids 805 so as to transform the solid model into an intermediate model 803 as shown in FIG. 8(a). From the intermediate model 803, step 114 may be applied to populate isostatic lines along principal stress directions of the stress field data of the intermediate model 803. Subsequently, step 122 may be applied to transform the intermediate model 803 into a spatially graded mesh model based on the orthogonal isostatic lines. Further, after topology optimization at step 122 of method 800, high density regions above a prescribed threshold may be converted to solid at step 823. Accordingly, the cells in the high density regions may be merged into solid regions. The load-bearing structure 801 as shown in FIG. 8(a) is an example of a beam subjected to distributed load. According to various embodiments, the load-bearing structure 801 may have a higher stiffness than a binary solid-void design or purely lattice design of the same mass. Accordingly, improvements in performance and manufacturability of the load-bearing structures according to the various embodiments may be achieved by configuring the structures to include solid and void (empty) regions, in addition to the lattice regions.

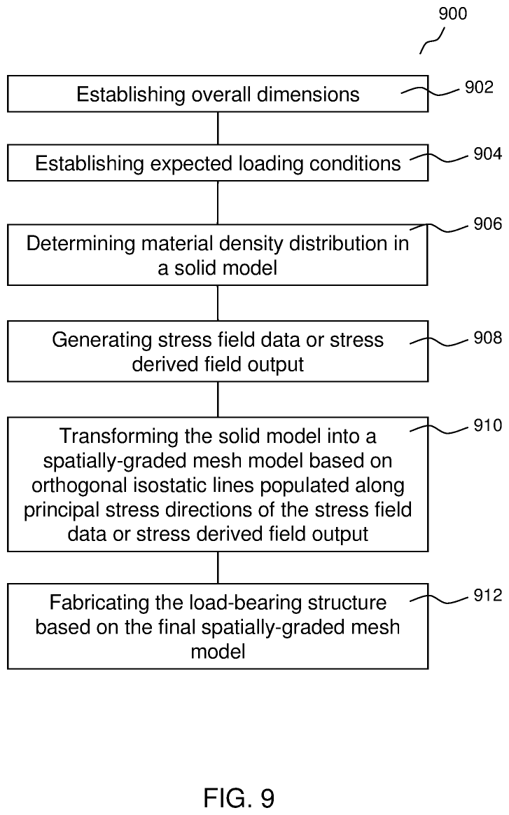

FIG. 9 shows a schematic diagram of a method 900 of manufacturing a load-bearing structure according to various embodiments. The method may include, at 902, establishing overall dimensions of the load-bearing structure. The overall dimensions may be the desired size and configuration of the load-bearing structure suitable for the purpose and use of the load-bearing structure. Further, the method may include, at 904, establishing expected loading conditions which the load-bearing structure is to be subjected to. The expected loading conditions may be based on the loading scenarios which the load-bearing structure may experience during normal usage.

According to various embodiments, the method may further include, at 906, determining a material density distribution within a solid model for the load-bearing structure based on the overall dimensions and the expected loading conditions for a predetermined objective end constraint. The predetermined objective end constraint may include a predetermined volume constraint, a predetermined mass constraint, a predetermined thermal load constraint, a predetermined vibration load constraint, or other predetermined constraint as required of the load-bearing structure. According to various embodiments, the material density distribution may be determined based on topology optimization and the material density distribution may be an optimized material density distribution of the solid model. Further, the predetermined objective end constraint may be a derived from a manufacturing constraint of a particular manufacturing technique.

According to various embodiments, the method may further include, at 908, generating stress field data or stress derived field output, for example strain which may be derived from stress, for the determined material density distribution based on the expected loading conditions. Accordingly, the stress field data may be the propagation of the stress throughout the model of the load-bearing structure or the distribution of internal forces within the model of the load-bearing structure having the determined material density distribution when the expected loading is applied.

According to various embodiments, the method may further include, at 910, transforming the solid model into a spatially-graded mesh model having a plurality of three-dimensional cells for the load-bearing structure based on orthogonal isostatic lines populated or generated along principal stress directions of the stress field data for the determined material density distribution. According to various embodiments, the orthogonal isostatic lines may segment the model of the load-bearing structure into a plurality of solid unit blocks. The plurality of solid unit blocks may be a plurality of irregularly-shaped solid unit blocks. Each solid unit block may define a geometry for the respective three-dimensional cell. Further, each solid unit block may be transformed into the respective three-dimensional cell based on local material density distribution of the respective solid unit block so as to transform the solid model into the spatially-graded mesh model. Accordingly, the spatially-graded mesh model may be a three-dimensional mesh with irregular shaped cells. According to various embodiments, the isostatic lines may be aligned with the principal stress trajectories and may be free of shear stress.

According to various embodiments, the method may further include, at 912, fabricating the load-bearing structure with truss members aligned according to the spatially-graded mesh model. According to various embodiments, fabrication may be via various manufacturing techniques, including by not limited to 3D printing, additive manufacturing etc.

According to various embodiments, the plurality of three-dimensional cells of the spatially-graded mesh model may include a plurality of three-dimensional lattice cells. Accordingly, transforming the solid model into a spatially-graded mesh model may include populating orthogonal isostatic lines along principal stress direction of the stress field data of the solid model, and transforming each solid unit block of the solid model segmented by the orthogonal isostatic lines into respective three-dimensional lattice cell with respective beam members based on respective local material density distribution within the respective solid unit block. According to various embodiments, the respective beam members of the respective three-dimensional lattice cell may correspond with portions of the respective orthogonal isostatic lines defining the respective solid unit block.

According to various embodiments, the method may further include interposing at least one node within each three-dimensional lattice cell of the plurality of three-dimensional lattice cells of the spatially-graded mesh model and connecting at least one node to at least one corner node of the respective lattice cell with a straight link member. Accordingly, each hexahedron three-dimensional lattice cell of the plurality of three-dimensional lattice cells may be transformed into at least one of a body centered cubic lattice cell, a face centered cubic lattice cell, a base centered cubic lattice cell, or a combination thereof.

According to various embodiments, the three-dimensional lattice cell may include an octet-truss lattice cell.

According to various embodiments, the method may further include discretising each curved beam member of each lattice cell of the plurality of three-dimensional lattice cells of the spatially-graded mesh model into a straight beam member. The isostatic lines populated in 910 may be curved which may result in the beam member of each cell of the spatially-graded mesh model to be curved. To facilitate subsequent fabrication of the load-bearing structure, the curved beams may be discretised into straight beams. According to various embodiments, the plurality of three-dimensional cells of the spatially-graded mesh model may include tetrahedron cell structure, hexahedron cell structure and pentahedron cell structure.

According to various embodiments, the method may further include individually determining a material density distribution within each beam member of each lattice cell of the plurality of three-dimensional lattice cell of the spatially-graded mesh model based on a length of the respective beam member and an expected axial loading of the respective beam member for a predetermined manufacturing constraint. According to various embodiments, the method may further include varying a diameter or a width of the respective beam member lengthwise based on the determined material density distribution. Accordingly, the respective member may have a variable diameter or width lengthwise (i.e. non-uniform diameters or width). According to various embodiments, the respective beam member may be tapered. According to various embodiments, the predetermined manufacturing constraint may be a predetermined fabrication limit in terms of a range of diameters or widths and a range of densities for a predetermined fabrication technique.

According to various embodiments, populating orthogonal isostatic lines along principal stress directions of the stress field data of the solid model may include resolving local principal stress directions of the stress field data at a predetermined starting point in the solid model, propagating the respective local principal stress directions based on resolving movement of the respective local principal stress directions from the predetermined staring point to obtain at least one pair of orthogonal isostatic lines, and populating successive isostatic lines from the at least one pair of orthogonal isostatic lines to form the spatially-graded mesh model based on a predetermined relative spacing. The predetermined relative spacing may be determined with a predetermined force per unit thickness conditions or by average spacing.

According to various embodiments, the method may further include cleaning up the spatially-graded mesh model by merging or deleting nodes of the spatially-graded mesh model which may be within a predetermined distance from each other. Accordingly, nodes that are too close together may be merged or deleted.

According to various embodiments, transforming the solid model into a spatially-graded mesh model may include transforming the solid model into an intermediate model by forming voids in the solid model based on applying a lower density threshold on the determined material density distribution of the solid model, wherein regions of the solid model with density lower that the lower density threshold are removed to form voids. Accordingly, the intermediate model may be formed when the determined material density distribution of the solid model include the void regions. Further, transforming the solid model into a spatially-graded mesh model may also include transforming the intermediate model into the spatially-graded mesh model based on applying an upper density threshold to the solid unit blocks segmented by the orthogonal isostatic lines such that solid unit blocks with local material density distribution higher than the higher density threshold remains as solid rather than transforming into lattice cell.

According to various embodiments, the plurality of three-dimensional cells of the spatially-graded mesh model may also include a plurality of three-dimensional box-like grid cells. Accordingly, transforming the solid model into a spatially-graded mesh model may include populating orthogonal isostatic lines along principal stress direction of the stress field data of the solid model, and transforming each solid unit block of the solid model segmented by the orthogonal isostatic lines into respective three-dimensional box-like grid cell with respective walls aligned corresponding with portions of the respective orthogonal isostatic lines defining the respective solid unit block based on respective local material density distribution within the respective solid unit block. Further, populating orthogonal isostatic lines along principal stress directions of the stress field data of the solid model may include resolving local principal stress directions of the stress field data at a predetermined starting point in the solid model, propagating the respective local principal stress directions based on resolving movement of the respective local principal stress directions from the predetermined starting point to obtain a pair of orthogonal isostatic lines, and populating successive isostatic lines from the at least the pair of orthogonal isostatic lines based on a predetermined relative spacing. Accordingly, transforming the solid model into a spatially-graded mesh model may include extruding the respective walls of the respective three-dimensional box-like grid cell from the pair of orthogonal isostatic lines.

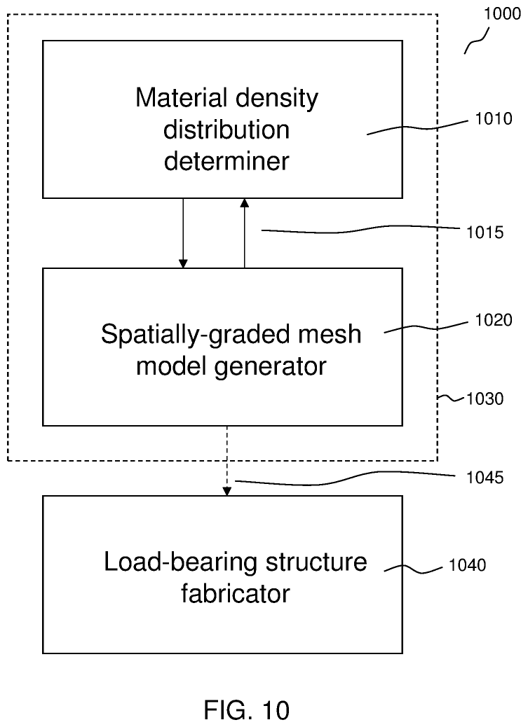

FIG. 10 shows a system 1000 for manufacturing a load-bearing structure according to various embodiments. According to various embodiments, the system 1000 may include a material density distribution determiner 1010. The material density distribution determiner 1010 may be configured to receive overall desired dimensions of the load-bearing structure and to receive expected loading conditions which the load-bearing structure is to be subjected to. Accordingly, a user may input the desired dimensions and expected loading conditions to the material density distribution determiner 1010. The material density distribution determiner 1010 may also be connected to an external computing or processing apparatus that may provide such inputs to the material density distribution determiner 1010.

According to various embodiments, the material density distribution determiner 1010 may be further configured to determine a material density distribution of a solid model of the load-bearing structure based on the overall dimensions and the loading conditions for a predetermined volume constraint. The material density distribution determiner 1010 may also be configured to generate stress field data of the load-bearing structure having the material density distribution based on the expected loading conditions.

According to various embodiments, the system 1000 may include a spatially-graded mesh model generator 1020. The spatially-graded mesh model generator 1020 may be in communication 1015 with the material density distribution determiner 1010 such that the material density distribution and the stress data may be communicated to the spatially-graded mesh model generator 1020. The spatially-graded mesh model generator 1020 may be configured to convert the solid model into a spatially-graded mesh model having a plurality of three-dimensional cells based on orthogonal isostatic lines populated along principal stress directions of the stress field data of the load-bearing structure.

According to various embodiments, the material density distribution determiner 1010 and the spatially-graded mesh model generator 1020 may be understood as any kind of a logic implementing entity, which may be special purpose circuitry or processor executing software stored in a memory, firmware, or any combination thereof. Thus, the material density distribution determiner 1010 and the spatially-graded mesh model generator 1020 may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). The material density distribution determiner 1010 and the spatially-graded mesh model generator 1020 may also be a processor executing software, e.g. any kind of computer program, e.g. a computer program using a virtual machine code such as e.g. Java. According to various embodiments, the material density distribution determiner 1010 and the spatially-graded mesh model generator 1020 may be separate logic implementing entity, such as separate processors, separate softwares, separate computer programs etc. According to various embodiments, the material density distribution determiner 1010 and the spatially-graded mesh model generator 1020 may be integrated into a single logic implementing entity 1030, such as a single processor, a single software, a single computer program etc.

According to various embodiments, the system 1000 may further include a load-bearing structure fabricator 1040 configured to fabricate the load-bearing structure with truss members aligned according to the spatially-graded mesh model generated. The load-bearing structure fabricator 1040 may be in communication 1045 with the spatially-graded mesh model generator 1020 such that the final spatially-graded mesh model generated may be output from the spatially-graded mesh model generator 1020 to the load-bearing structure fabricator 1040 for fabrication of the load-bearing structure. According to various embodiments, the load-bearing structure fabricator 1040 may be configured for three-dimensional (3D) printing or additive manufacturing. Accordingly, the load-bearing structure fabricator 1040 may be a 3D printer or an additive manufacturing apparatus.

According to various embodiments, the material density distribution determiner 1010 may be further configured to individually determine a material density distribution within each member of each cell of the plurality of three-dimensional cells of the spatially-graded mesh model based on a length of the respective member and an expected axial loading of the respective member for a predetermined manufacturing constraint. Further, the material density distribution determiner 1010 may be further configured to vary a diameter or a width of the respective member lengthwise based on the determined material density distribution. Accordingly, the spatially-graded mesh model generator 1020 may be in two-way communication 1015 with the material density distribution determiner 1010 such that the spatially-graded mesh model may be communicated back to the material density distribution determiner 1010 for determining the individual dimension of the individual member. Subsequently, the final spatially-graded mesh model may then be communicated to the load-bearing structure fabricator 1040.

According to various embodiments, the spatially-graded mesh model generator 1020 may be configured to resolve local principal stress directions of the stress field data at a predetermined starting point in the solid model of the load-bearing structure. The spatially-graded mesh model generator 1020 may also be configured to propagate respective local principal stress directions based on resolving movement of the respective local principal stress directions from the predetermined stress to obtain a pair of orthogonal isostatic lines. Further, the spatially-graded mesh model generator 1020 may be configured to populate successive isostatic lines from the pair of orthogonal isostatic lines based on a predetermined relative spacing. The predetermined relative spacing may be determined with a predetermined force per unit thickness conditions or by average spacing.

According to various embodiments, the spatially-graded mesh model generator 1020 may be further configured to clean up the spatially-graded mesh model by merging or deleting nodes of the spatially-graded mesh model which are within a predetermined distance from each other.

Referring back to FIG. 5(c), various embodiments have also provided a load-bearing structure 500. The load-bearing structure 500 may include truss members 510 aligned according to a spatially-graded mesh model, for example as shown in FIG. 6(b). Accordingly, the truss members 510 may form a lattice structure conforming to the spatially-graded mesh model. Referring to FIG. 6(b), according to various embodiments, the spatially-graded mesh model 600 may include a plurality of three-dimensional cells 610. The plurality of three-dimensional cells 610 may include hexahedron cells 612 and pentahedron cells 614. According to various embodiments, side members 620 of each cell of the plurality of three-dimensional cells 610 of the spatially-graded mesh model 600 may be aligned to orthogonal isostatic lines 605, 607 populated along local principal stress directions of the stress field data generated for a material distribution density of a solid model for the load-bearing structure which is determined based on overall dimensions of the load-bearing structure and expected loading conditions of the load-bearing structure for a predetermined objective end constraint. According to various embodiments, each side member 620 of each cell of the plurality of three-dimensional cells 610 of the spatially-graded mesh model 600 may be a straight side member. According to various embodiments, a central node 630 may be interposed in each hexahedron cell 612 of the plurality of three-dimensional cells 610 of the spatially-graded mesh model 600 and the central node 630 may be connected to each corner node of the respective hexahedron cell via straight link members 640. The straight link members 640 may extend from a corner node and between two adjoining side members of each cell.

According to various embodiments, each member 620, 640 of each cell of the plurality of three-dimensional cell 610 of the spatially-graded mesh model 600 may include a varying diameter or width lengthwise. Accordingly, each member 620, 640 may include varying cross-sectional diameters or widths.

According to various embodiments, the varying diameter or a width of the respective member 620, 640 may be within a predetermined fabrication limit in terms of a range of diameters or widths and a range of densities for a predetermined fabrication technique.

According to various embodiments, the spatially-graded mesh model further comprises a face-centered-node 650 interposed in a face of each pentahedron cell 614 of the plurality of three-dimensional cells 610 wherein the face of the respective pentahedron cell 614 is along a boundary of the spatially-graded mesh model 600. The face-centered-node 650 may be connected to each corner node of the respective pentahedron cell 614 via straight link members. The straight link members may extend from a corner node and between two adjoining side members of each cell.

According to various embodiments, the load-bearing structure 500 may be fabricated via three-dimensional (3D) printing or additive manufacturing.

Various embodiments have provided a load-bearing structure with improvement in stiffness and strength. Various embodiments have provided a spatially-graded lattice structure with a greater number of variables available for optimization. These additional degrees of freedom may be introduced using a novel isostatic line method developed, which may functionally grades the lattice cells in terms of size, aspect ratio and orientation to align the load-bearing truss members with the principal stresses within the load-bearing structure. Various embodiments have enabled the construction of functionally graded lattice structures with optimized cell size, cell orientation and cell aspect ratios in order to achieve superior strength and stiffness of lightweight load-bearing structures.

In the following, a comparison of the performance between the load-bearing structure 500 (or the spatially-graded lattice structure) in FIG. 5(c) with respect to the uniform lattice structure 501 in FIG. 5(a) and the diameter-graded lattice structure 503 in FIG. 5(b) is presented.

Three point bend tests for each of the specimen were performed with an Instron 5982 machine using a 10 kN load cell under quasi-static conditions. In addition to cross-head displacement and load cell data, the mid-point deflection of the lower surface was also recorded using an extensometer with a 25 mm gauge length. A digital image correlation system was also used to record the displacement field of the sandwich structure's side wall. A black and white speckle pattern was applied to the side wall to provide sufficient contrast for the digital image correlation system to detect changes in displacement.

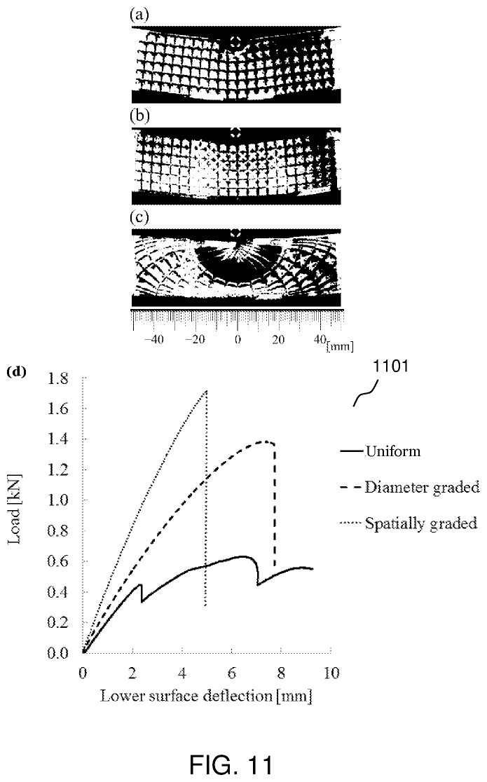

FIG. 11 show the experimental force-displacement characteristics of all three sandwich structures under three point bending. FIG. 11(a) shows vertical deflection for the uniform lattice structure 501 of FIG. 5(a) at end of test. FIG. 11(b) shows vertical deflection for the diameter-graded lattice structure 503 of FIG. 5(b) at ultimate load. FIG. 11(c) shows vertical deflection for the spatially-graded lattice structure 500 of FIG. 5(c) at the onset of localized buckling. FIG. 11(d) shows a graph 1101 illustrating the experimental force-displacement results.

The load values in FIG. 11 are without finite width corrections applied, and the lower surface deflections are calculated from the extensometer data. After finite width corrections, the experimental results show an increase in strength and stiffness of 119.4% and 30.1%, respectively, for the diameter graded structure 503 compared to the uniform lattice structure 501. The improvement in performance of the spatially graded sandwich structure 500 is even better with stiffness and strength increasing by 172.0% and 100.7%, respectively, when compared with the uniform lattice structure 501.

The digital image correlation results for vertical deflection are also provided in FIG. 11 along with images showing the various failure modes observed in the respective sandwich structures. The uniform lattice structure 501 was observed to undergo progressive core crushing about the loading point. This type of failure mode is characteristic of sandwich structures. The result of progressive core crushing can also be observed in the graph 1101 of FIG. 11(d) whereby the initial linear stiffness transitions to highly nonlinear permanent deformation once failure is initiated. The diameter-graded lattice structure 503 on the other hand has distinctively brittle response characteristics with relatively linear stiffness up to the point of catastrophic failure.

The force-displacement response of the spatially-graded structure 500 was also brittle with an almost perfectly linear response prior to failure. In comparison to the other two lattice structures 501, 503, the spatially-graded structure 500 failed by local buckling of its longer lattice members in triangular cell configuration (or pentahedron cell) near the location of the applied load. The deformation of the spatially-graded structure 500 close to the point of buckling can be seen in FIG. 11(c) with the digital image correlation capable of detecting the onset of localized buckling as the lattice members start to rotate in an anti-clockwise manner.

Table 1 in the following shows the respective sandwich structure performance.

TABLE 1
sandwich structure performance

| | | | Diameter-graded | | Spatially-graded | |
|---|---|---|---|---|---|---|
| | Uniform | | Test | FE | Test | FE |
| | Test | FE | (% change) | (% change) | (% change) | (% change) |
| Max. load, P_{y} [N] | 631^{a} | 1203 | 1385^{b} | 1474 | 1717^{c} | 1804 |
| | | | (119.4%) | (22.6%) | (172.0%) | (50.0%) |
| $\begin{matrix}Initial stiffness , \frac{P}{δ} \\ [ N \text{/} mm ]\end{matrix}$ | 210 | 289 | 274 (30.1%) | 334 (15.5%) | 422 (100.7%) | 528 (82.4%) |
| Deflection at max. | 6.56 | 4.16 | 7.37 | 4.41 | 5.00 | 3.42 |
| load δ_{y} [mm] | | | | | | |

^{a}Failure by core crushing
^{b}Brittle failure
^{c}Buckling of lattice members near loading point

The core performance indices related to shear stiffness, Young's modulus and yield strength are provided in Table 3 below. The non-dimensional core densities of the three configurations are also provided, where ρ^{cl}=1 would represent the density of the parent material. After applying the relevant finite width correction factors, provided in Table 2 below, it was found that all three configurations have core densities close to the target 25% volume fraction specified in the topology optimization procedure. The similarity in core density and the similar total number of lattice cells makes the comparison between the three core configurations as fair as possible. The small variations in core densities are primarily caused by geometry details such as finite model widths, the assumption of mid-plane symmetry, and other areas in the model such as the skin-core interface and lattice node details, where volumes of the finite elements overlap. All values presented in Table 3 are dimensionless since the analysis procedure is independent of material properties, so long as the constituent material is isotropic with a Poisson's ratio of 0.3.

TABLE 2
Volumetric finite width correction factors for core material properties

| | Uniform | Diameter-graded | Spatially-graded |
|---|---|---|---|
| Finite Element (w = 1) | 0.635 | 0.587 | 0.472 |
| Experiment (w = 61) | 0.998 | 0.978 | 0.932 |

TABLE 3
Non-dimensional core performance indices

| | Benchmark | | Diameter-graded | | Spatially graded | |
|---|---|---|---|---|---|---|
| | (ρ^{c} = 0.252) | | (ρ^{c} = 0.247) | | (ρ^{c} = 0.277) | |
| | Test | FE | Test | FE | Test | FE |
| $\frac{{G}^{c}}{{ρ}^{c}}$ | 0.16 | 0.22 | 0.49 | 0.36 | 0.18 | 0.21 |
| $\frac{\sqrt[3]{{E}^{c}}}{{ρ}^{c}}$ | 0.53 | 1.73 | 2.21 | 1.62 | 2.90 | 3.10 |
| $\begin{matrix}{\underline{\sqrt{{σ}_{y}^{c}}}}^{c} \\ ρ\end{matrix}$ | 0.12 | 1.03 | 1.12 | 1.09 | 1.39 | 2.11 |

The shear modulus performance indices

$$\frac{{G}^{σ}}{{ρ}^{c}}$$

for all three core configurations are significantly below unity. A value of 1 would indicate identical performance to the parent material. The poor shear performance of all three cores may not be surprising as it is a result of the inherently poor shear characteristics of the BCC cell when compared with the equivalent bulk material. All three performance indices are below unity for the experimental results for the uniform lattice structure 501. The strength performance index of 0.12 is particularly low as a result of the early onset of localized core crushing. Similarly, the experimental strength performance index for the spatially-graded cell of 1.39 is also lower than expected as a result of the early onset of localized buckling. But otherwise the experimental and numerically predicted core performance indices show consistent trends with the experimental data.

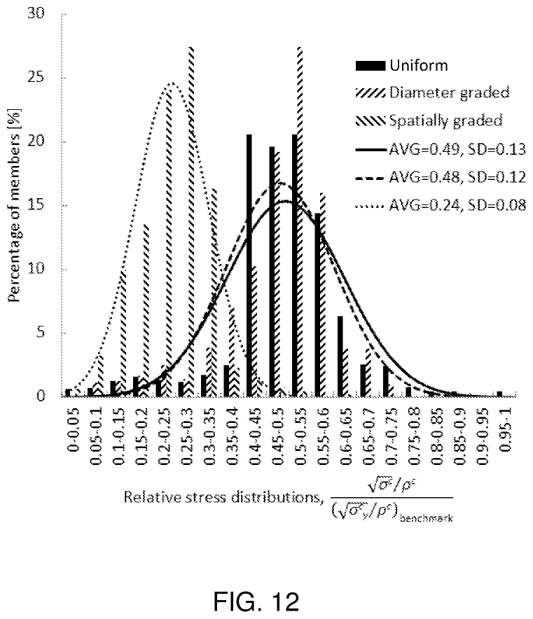

FIG. 12 shows the normal distributions of maximum von Mises stress in the finite element models' lattice members. The maximum von Mises stress distributions within the three structures show an interesting trend consistent with the experimental results. The stresses in FIG. 12 are normalized with respect to the yield strength of the benchmark finite element model. Again, the uniform lattice structure 501 and diameter-graded lattice structure 503 are shown to have near identical performance whereas the average von Mises stress in the spatially-graded lattice structure 500 is significantly reduced, along with the standard deviation in stresses. The reduction in the average stress and the standard deviation in the spatially graded lattice structure 500 may be due to orientating and sizing the lattice cells to reflect the positions of the theoretical isostatic lines. By using isostatic lines it should be theoretically possible to achieve a homogeneous von Mises stress distribution although in practice the discretisation of the isostatic lines into finite elements and other geometric details, such as model boundaries, will result in some variability.

While the invention has been particularly shown and described with reference to specific embodiments, it should be understood by those skilled in the art that various changes, modification, variation in form and detail may be made therein without departing from the scope of the invention as defined by the appended claims. The scope of the invention is thus indicated by the appended claims and all changes which come within the meaning and range of equivalency of the claims are therefore intended to be embraced.

1. A method of manufacturing a load-bearing structure, the method comprising:
establishing overall dimensions of the load-bearing structure;
establishing expected loading conditions which the load-bearing structure is to be subjected to;
determining a material density distribution within a solid model for the load-bearing structure based on the overall dimensions and the expected loading conditions for a predetermined objective end constraint;
generating stress field data for the determined material density distribution based on the expected loading conditions;
transforming the solid model into a spatially-graded mesh model having a plurality of three-dimensional cells for the load-bearing structure based on orthogonal isostatic lines populated along principal stress directions of the stress field data for the determined material density distribution; and
fabricating the load-bearing structure with truss members aligned according to the spatially-graded mesh model.

2. (canceled)

3. The method as claimed in claim 1, wherein the plurality of three-dimensional cells of the spatially-graded mesh model comprises a plurality of three-dimensional lattice cells, and wherein transforming the solid model into a spatially-graded mesh model comprises:
populating orthogonal isostatic lines along principal stress direction of the stress field data; and
transforming each solid unit block of the solid model into respective three-dimensional lattice cell with respective beam members based on respective local material density distribution within the respective solid unit block, wherein the solid model is segmented into a plurality of solid unit blocks by the orthogonal isostatic lines.

4. The method as claimed in claim 3, wherein the respective beam members of the respective three-dimensional lattice cell correspond with portions of the respective orthogonal isostatic lines defining the respective solid unit block.

5. The method as claimed in claim 4, further comprising interposing at least one node within each three-dimensional lattice cell of the plurality of three-dimensional lattice cells of the spatially-graded mesh model and connecting the at least one node to at least one corner node of the respective lattice cell with a straight link member.

6. The method as claimed in claim 5, wherein each hexahedron three-dimensional lattice cell of the plurality of three-dimensional lattice cells is transformed into at least one of a body centered cubic lattice cell, a face centered cubic lattice cell, a base centered cubic lattice cell, or a combination thereof.

7. (canceled)

8. The method as claimed in claim 2, further comprising discretising each curved beam member of each lattice cell of the plurality of three-dimensional lattice cells of the spatially-graded mesh model into a straight beam member.

9. The method as claimed in claim 2, further comprising individually determining a material density distribution within each beam member of each lattice cell of the plurality of three-dimensional lattice cells of the spatially-graded mesh model based on a length of the respective beam member and an expected axial loading of the respective beam member for a predetermined manufacturing constraint.

10. The method as claimed in claim 9, further comprising varying a diameter or a width of the respective beam member lengthwise based on the determined material density distribution.

11. The method as claimed in claim 9, wherein the predetermined manufacturing constraint is a predetermined fabrication limit in terms of a range of diameters or widths and a range of densities for a predetermined fabrication technique.

12. The method as claimed in claim 3, wherein populating orthogonal isostatic lines along principal stress directions of the stress field data comprises:
resolving local principal stress directions of the stress field data at a predetermined starting point in the solid model;
propagating the respective local principal stress directions based on resolving movement of the respective local principal stress directions from the predetermined starting point to obtain at least one pair of orthogonal isostatic lines; and
populating successive isostatic lines from the at least one pair of orthogonal isostatic lines based on a predetermined relative spacing.

13. The method as claimed in claim 2, further comprising cleaning up the spatially-graded mesh model by merging or deleting nodes of the spatially-graded mesh model which are within a predetermined distance from each other.

14. (canceled)

15. The method as claimed in claim 1, wherein the plurality of three-dimensional cells of the spatially-graded mesh model comprises a plurality of three-dimensional box-like grid cells.

16. The method as claimed in claim 15, wherein transforming the solid model into a spatially-graded mesh model comprises:
populating orthogonal isostatic lines along principal stress direction of the stress field data;
transforming each solid unit block of the solid model into respective three-dimensional box-like grid cell with respective walls aligned corresponding with portions of the respective orthogonal isostatic lines based on respective local material density distribution within the respective solid unit block, wherein the solid model is segmented into a plurality of solid unit block by the orthogonal isostatic lines.

17. The method as claimed in claim 16, wherein populating orthogonal isostatic lines along principal stress directions of the stress field data comprises:
resolving local principal stress directions of the stress field data at a predetermined starting point in the solid model;
propagating the respective local principal stress directions based on resolving movement of the respective local principal stress directions from the predetermined starting point to obtain a pair of orthogonal isostatic lines; and
populating successive isostatic lines from the at least the pair of orthogonal isostatic lines based on a predetermined relative spacing.

18. The method as claimed in claim 17, wherein transforming comprises extruding the respective walls of the respective three-dimensional box-like grid cell from the pair of orthogonal isostatic lines.

19. A system for manufacturing a load-bearing structure, the system comprising:
a material density distribution determiner configured to receive overall desired dimensions of the load-bearing structure, to receive expected loading conditions which the load-bearing structure is to be subjected to, to determine a material density distribution of a solid model for the load-bearing structure based on the overall dimensions and the loading conditions for a predetermined objective end constraint, and to generate stress field data for the material density distribution based on the expected loading conditions;
a spatially-graded mesh model generator configured to transform the solid model into a spatially-graded mesh model having a plurality of three-dimensional cells based on orthogonal isostatic lines populated along principal stress directions of the stress field data for the determined material density distribution; and
a load-bearing structure fabricator configured to fabricate the load-bearing structure with truss members aligned according to the spatially-graded mesh model generated.

20. The system as claimed in claim 19, wherein the material density distribution determiner is further configured to individually determine a material density distribution within each member of each cell of the plurality of three-dimensional cells of the spatially-graded mesh model based on a length of the respective member and an expected axial loading of the respective member for a predetermined manufacturing constraint.

21. The system as claimed in claim 20, wherein the material density distribution determiner is further configured to vary a diameter or a width of the respective member lengthwise based on the determined material density distribution.

22. The system as claimed in claim 19, wherein the spatially-graded mesh model generator is configured to resolve local principal stress directions of the stress field data at a predetermined starting point in the solid model; to propagate respective local principal stress directions based on resolving movement of the respective local principal stress directions from the predetermined starting point to obtain at least one pair of orthogonal isostatic lines; and to populate successive isostatic lines from the at least one pair of orthogonal isostatic lines based on a predetermined relative spacing determined.

23. The system as claimed in claim 19, wherein the spatially-graded mesh model generator is further configured to clean up the spatially-graded mesh model by merging or deleting nodes of the spatially-graded mesh model which are within a predetermined distance from each other.

24.-30. (canceled)
